(19) United States
(12) Patent Application Publication
(10) Pub. No.: US 2024/0239172 A1
(43) Pub. Date: Jul. 18, 2024

(54) THROWABLE ROBOT WITH ENHANCED PERFORMANCE AND SURVIVABILITY

(71) Applicant: ReconRobotics, Inc., Edina, MN (US)

(72) Inventors: Alex J. Kossett, Minnetonka, MN (US); Andrew Drenner, Savage, MN (US)

(21) Appl. No.: 18/402,629

(22) Filed: Jan. 2, 2024

Related U.S. Application Data
(60) Provisional application No. 63/436,818, filed on Jan. 3, 2023.

(51) Int. Cl. B60K 1/02; B25J 5/00; B60K 1/04; B60K 17/04; F41H 7/00

(52) U.S. Cl. CPC B60K 1/02; B25J 5/007; B60K 1/04; B60K 17/043; F41H 7/005

(57) ABSTRACT

A two wheeled throwable robot comprises an elongate robot body with an axis supporting two drive wheels and a rearward tail extending from the robot body. The robot body comprising an elongate chassis with two ends, a motor at each end, the motors connecting to the drive wheels through gear and clutch systems supported by the chassis, sensors and operational components positioned at the front of the chassis, processing circuitry, radio, memory, power control circuitry are located in the chassis such as the circuitry compartments and may be sealingly contained therein. The chassis having a main chassis body that provides enhanced structural strength by supporting the drive motors in conforming bores and having a plurality of U-shaped recesses for receiving a forward chassis body component and a battery module. Additional recesses on the ends of the main body component, along with end chassis caps define drive system compartments for gear systems and clutch mechanism that are isolated from the interior circuitry compartments and the drive motors.

### CROSS-REFERENCE TO RELATED APPLICATIONS

This application claims priority to U.S. Provisional Application No. 63/436,818 filed on Jan. 3, 3023, and titled Throwable Robot with Enhanced Performance and Survivability. The application is incorporated by reference herein.

### BACKGROUND OF THE INVENTION

Throwable robots for use in military and police operations need to be highly durable and robust to reliably perform under difficult conditions. Additionally, such robots ideally have capabilities for mounting accessories and payloads, quick recharge of batteries, robust imaging capabilities, significant processing power. Any incremental improvements in reliability and performance for robots used in high stakes military and police operations are desirable. Ideally such robots can absorb substantial falls, and other shock conditions, moisture, and other contaminants.

### SUMMARY OF THE INVENTION

A two wheeled throwable robot comprises an elongate robot body with an axis supporting two drive wheels and a rearward tail extending from the robot body. Axis of the drive wheels and body axis are coextensive or parallel and offset. The robot body comprising an elongate chassis with two ends, a motor at each end, the motors connecting to the drive wheels through gear and clutch systems supported by the chassis, sensors and operational components positioned at the front of the chassis, processing circuitry, radio, memory, power control circuitry are located in the chassis such as the circuitry compartments and may be sealingly contained therein.

The elongate chassis having end portions that have each have a generally cylindrical shape. The robot body axis is generally coextensive with the chassis axis. The chassis and providing a clearance between an exterior surface of the chassis and the exterior periphery of the drive wheels. The chassis being compartmentalized for isolating, structurally supporting, and protecting particularly componentry of the robot body while still providing serviceability and enhanced structural strength such as for absorbing shock from throws or other shock conditions. In embodiments, the chassis having an elongate payload recess on a top side of the chassis for receiving payloads such as accessories, an elongate battery module recess on the bottom side of the chassis, axial bores for receiving drive motors above the battery module recess, one or more forward circuitry compartments positioned behind forward portals for sensors and illumination, and drive system compartments on each lateral end of the chassis for gear and clutching systems. The compartments and recesses defined by a main chassis body and a forward chassis body, and two chassis end caps. The forward chassis body received by a forward facing recess on a forward side of the main chassis body, the one or more circuitry compartments defined by the main chassis body and forward chassis body. A seal or gasket may be positioned at the juncture between the forward chassis body and the main chassis body.

The payload recess extending substantially the axial length of the chassis, with the chassis having a pair of lateral end walls defining the payload recess. In embodiments, the payload recess being open upwardly, forwardly, and rearwardly, thereby maximizing the volumetric carrying capability of the robot. In embodiments, the chassis having one or more upwardly facing flat surfaces substantially defining the lower boundary of the recess. The robot having an electrical connector exposed upwardly on the chassis at the one or more flat surfaces for connecting with the payload and further having a plurality of threaded holes facing upwardly for attachment of payload or other accessories.

The elongate axially extending battery module recess open downwardly and rearwardly and positioned on a bottom side and rearward side of the chassis. The chassis having a pair of battery recess endwalls that define the lateral ends of the battery module recess. The battery module recess having a concave shape when viewed in cross section. An electrical battery connector is positioned on the chassis in the recess for connecting to the battery enclosure. When the battery module is connected to the robot in the battery module recess, the battery module seats in-between the pair of battery recess endwalls and a rearward side and a downward side of the battery module is exposed. The chassis having a plurality of threaded holes for attaching the battery module to the chassis with threaded fasteners. Two ends of the battery module engage and/or confront the respective battery recess endwalls of the chassis.

In embodiments, the chassis having a main chassis body and a forward chassis body that functions as a cover over one or more circuitry compartments and may further have compartment recesses partially defining the one or more circuitry compartments. The forward chassis body providing a plurality of front side chassis portals for forward directed sensors and operational components of the robot. Such sensors and operational components may be mounted on boards or brackets in the circuitry compartments to be positioned at or extend through the front portals of the chassis. The forward chassis body extending from the bottom side of the robot body to the top side and may partially define the flat surfaces on the top of the chassis that receive the payload and accessories. That is, a juncture between the forward chassis body and main chassis body may extend axially on the top side of the robot body substantially the axial length of the chassis. The lateral ends of the forward chassis body may be spaced inwardly from the lateral ends of the chassis and may further have a pair of radially extending walls partially defining the one or more circuitry compartments and providing an exterior axial facing surface to confront and or engage a pair of walls.

The main body portion of the chassis having a pair of axial end portions that define a pair of drive system compartments that sealingly contain a gear drive system and clutch system. The chassis may have walls with inward surfaces at the recess for receiving the forward chassis body. A pair of end caps extend over and further have recesses partially defining the drive system compartments. The endcaps may be sealingly attached with engaging or confronting cylindrical surfaces, engaging circular and axially facing surfaces and a plurality of threaded fasteners circularly spaced about a peripheries of the respective drive system compartments, clamping the circular and axially facing surfaces together. The drive system compartments may have a shape that is cylindrical with a portion that bulges radially outwardly for accommodating the drive gear connected to the drive motor. One or both of the pair of lateral endwalls that define the payload receiving recess may further be a wall partially defining the pair of drive system compartments. One or both of the pair of battery recess endwalls may also be a wall that partially defines the pair of drive system compartments.

The bores for the drive motors may be configured to conform to most of the external surface of the drive motor providing secure attachment within the robot body during impact. A feature and advantage of embodiments is that the bores for receiving the motor are in the main chassis body and are not located at a juncture of the main chassis body and forward chassis body. A feature and advantage is the most of the outer surface area of the cylindrical shaped drive motors confront and/or contact the conforming surface area of the bore in the chassis. The drive motors may each have a flange attached to the drive shaft end of the drive motor with screws and the flange may connect to the main chassis body at an aperture leading into the drive motor receiving bore of the chassis.

A feature and advantage of the throwable robot is that the main chassis body has three axially extending recesses for receiving 1) payload, 2) a battery module, and 3) the forward chassis body with portals. Each of the recesses having a U-shape when viewed in an axial cross section of a plane through the axis of the chassis or robot body. The recesses each spaced from the axial ends of the chassis. The battery module and forward chassis body each providing an exterior surface to the robot body that is generally cylindrical.

A feature and advantage of the throwable robot is that the main chassis body has axial end recesses that viewed in cross section at a plane through the chassis or body axis defines a U-shape facing axially outward. The end caps are received into the recesses such that impacts thereto are absorbed in the U-shape recesses and do not provide a shear force that urges component separation. The chassis end cap and the recess of the main chassis body providing a compartment that isolates the gearing and clutch mechanism from environmental contaminants and further isolates the circuitry compartment from the drive system compartments. The drive system compartment having the drive motor shaft entering it, the drive wheel axle exiting it, and it may otherwise be sealed.

A feature and advantage of the layout is the vulnerable PCB associated with circuitry is secured in compartments that provide a high level of containment integrity and a high level of structural strength. A feature and advantage of the chassis design is that impacts to the forward chassis body or to the battery module will typically be absorbed by the confronting surfaces of the forward chassis body and the main chassis body or the confronting surfaces of the battery module and main chassis body. That is such impacts do not impart meaningful shear separation forces that could cause failures at the juncture of the chassis components. Similarly, impacts on the ends of the robot impart shock forces to the chassis end caps which are received in the A features and advantage of embodiments of the invention over known art throwable robots is increased volume for the batteries and the batteries of the battery module may be readily swapped out with another battery module rather than needing to recharge the battery when the battery energy level is low. A feature and advantage is that the battery module shape and attachment arrangement provides increased structural strength to the robot body making the body less vulnerable to damage when thrown. A feature and advantage is that the battery module may take impact shocks and may be less vulnerable to damage compared to a conventional chassis and may be readily replaced if damaged.

A feature and advantage of embodiments of the invention over known throwable robots is a novel motor mounting system which can accommodate motors more securely and can readily accommodate motors with encoders.

A feature and advantage of embodiments of the robot may sustain impact shocks to the two drive wheels better than conventional two wheeled robots in that the axle connecting to each drive wheel is secured at two axially displaced locations in chassis bushings. One bushing in the main chassis body and one bushing in the chassis end cap. The main driven gear and clutch mechanism positioned on the axle in between the two bushings. The two bushings separated by at least 1 inch in embodiments. In embodiments, the two bushings separated by at least 1.5 inches. In embodiments the two bushings not separated by more than three inches.

A feature and advantage of embodiments of the invention over known throwable robots is an Integrated digital video—can be processed onboard, video overlays can be added

A feature and advantage of embodiments of the invention over known throwable robots is a significantly increased processing power (can now process video onboard, potential for increased autonomy).

A feature and advantage of embodiments of the invention over known throwable robots that contributes to the modularity, is that all major components connect through board to board connectors.

### BRIEF DESCRIPTION OF THE DRAWINGS

FIG. 1 is a rear perspective view of a throwable robot according to embodiments with accessories mounted on a top side recess.

FIG. 2 is a front perspective view of the throwable robot of FIG. 1.

FIG. 3 is a side perspective view of a robot with a mounting rail provided at the accessory mounting top recess.

FIG. 4 is a front perspective view of the robot of FIG. 3 with the rail removed illustrating the top side accessory recess.

FIG. 5 is a front perspective view of another throwable robot with wheels and a tail of reduced size compared to the robots of FIGS. 1-4.

FIG. 6 is a rear perspective view of the robot of FIG. 5 with the accessories removed and a rail for accessories mounted at the top side accessory recess.

FIG. 7A is a front elevational view of the main chassis component and the forward chassis component engaged therewith.

FIG. 7B is a perspective view of the main chassis component and the forward chassis component engaged therewith.

FIG. 7C is a cross sectional view of the main chassis component and the forward chassis component at line 7C-7C of FIG. 7A.

FIG. 8A is an exploded view of chassis components according to embodiments.

FIG. 8B is another exploded view of the chassis components of FIG. 8A.

FIG. 9, is a perspective view of a main chassis body component of the robots of FIGS. 1-6.

FIG. 10 is another perspective view of the main chassis body component of FIG. 9.

FIG. 11 is another perspective view of the main chassis body component of FIG. 9.

FIG. 12 is a cross sectional view of the main chassis body portion taken at plane 12-12.

FIG. 13 is a cross sectional view of the main chassis body portion taken at plane 13-13.

FIG. 14 is a cross sectional view of the main chassis body portion taken at plane 14-14.

FIG. 15 is a cross sectional view of the main chassis body portion taken at plane 15-15.

FIG. 16 is a perspective view of the internal componentry secured within the chassis of embodiments without the chassis.

FIG. 17 is another perspective view of the internal componentry of FIG. 16.

FIG. 18 is a rearward upwardly looking perspective of a robot illustrating the location of a battery module.

FIG. 19 is a rearward perspective view of the robot of FIG. 18 with the battery module separated from the chassis of the robot.

FIG. 20 is another view of the robot of FIG. 19 with the separated battery module.

FIG. 21 is a view of the robot of FIGS. 18-20 with a front chassis component removed from a U-shaped forward facing recess.

FIG. 22 is another view of the robot of FIG. 21 with the separated front chassis component.

FIG. 23 is another view of the robot of FIG. 21 with the separated front chassis component.

FIG. 24 is a view of the robot of FIG. 4 with the front chassis component separated.

FIG. 25 is a perspective view of the robot of FIG. 5 with the top side accessory package separated from the top side U-shaped recess.

FIG. 26 is another perspective view of the robot of FIG. 5 with the accessory package removed.

FIG. 27 is an exploded view of a drive system for a drive wheel of embodiments.

FIG. 28 is an exploded view of the drive system of claim 27 taken from the opposite side.

FIG. 29 is a view of the drive system of FIGS. 27 and 28 with the chassis removed illustrating the drive motor with encoder.

FIG. 30 is an exploded view of the drive system of FIG. 28 at a different view.

### DETAILED DESCRIPTION

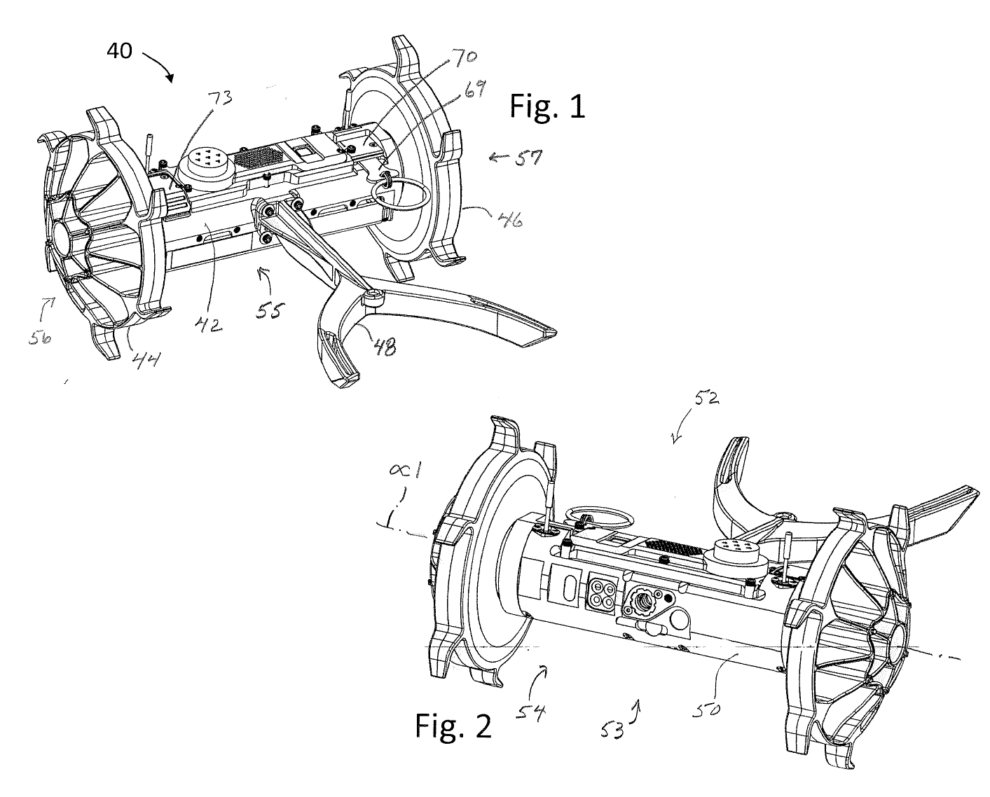

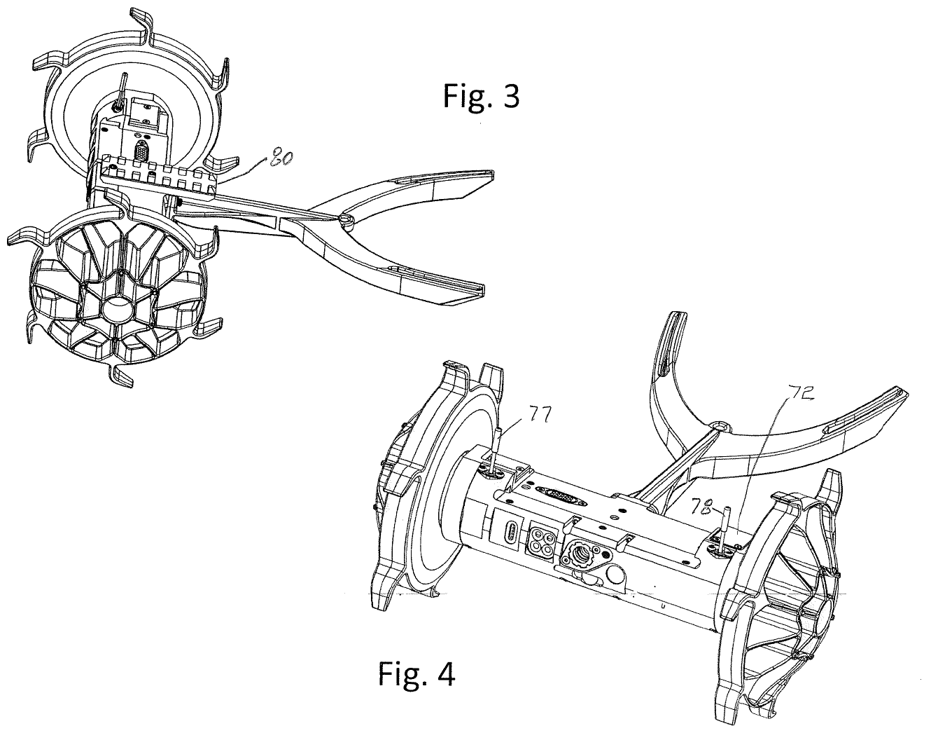

Referring to FIGS. 1-4, a two wheeled throwable robot 40 comprises body 42 supporting a pair of drive wheels 44, 46 and with a tail 48 extending rearwardly from the body. The body comprises a chassis 50 that supports operational componentry for the driving, surveillance and other functionalities of the robot. The robot body 42 and chassis 50 generally have an axis al. The robot, body, and chassis all generally have a top side 52, a bottom side 53, a front side 54, a rear side 55, a port side 56 and a starboard side 57.

Exposed on the front side of the robot are a high definition 1080p camera 60, a thermal camera 62, IR and visible illumination source 64, and a passive IR sensor 65 for motion detection. On the top side, an accessor recess 67, best shown in FIG. 4, spans most of the distance between the drive wheels 44, 46 and an accessory package 68 shown in FIGS. 1 and 2 is attached to the robot at the accessory recess.

The accessories may include sensors, additional communication components, munitions, environmental sensing, environmental effecting components including munitions. Additional accessories and systems associated with the accessories, including mounting and protection components are disclosed in U.S. Pat. No. 11,479,102 and publication WO 2021/102060, both owned by the owner of the instant application, and both incorporated herein by reference for all purposes.

The top side may also include a pull to activate key 69 and key sensor 70, a USB connector 72 with a cover 73 (see FIG. 1), an electrical connector terminal 75 for the attached accessories, antennas 77, 78 for a radio(s). See US 2021/0362355 for details on suitable magnetic lock systems for throwable robots. The publication is incorporated herein by reference for all purposes.

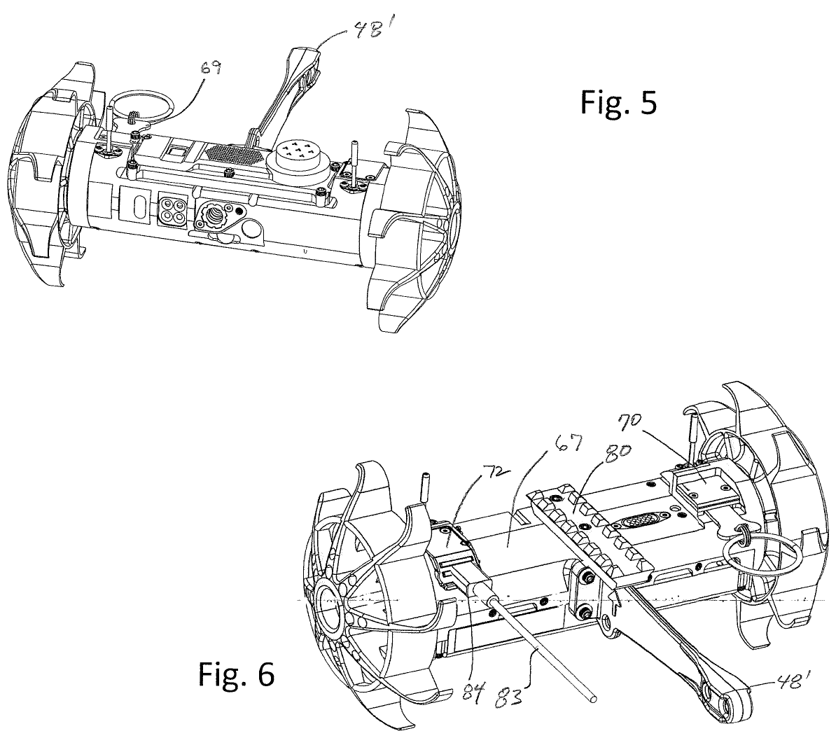

Referring to FIGS. 5 and 6, additional configurations of embodiments include robots with reduced diameter wheels 44′, 46′, and reduced sized of the robot tail 48′. FIG. 6 illustrates an accessory rail 80, such as a picatinny rail mounted in the accessory recess, and a connector cable 83 with a USB connector 84

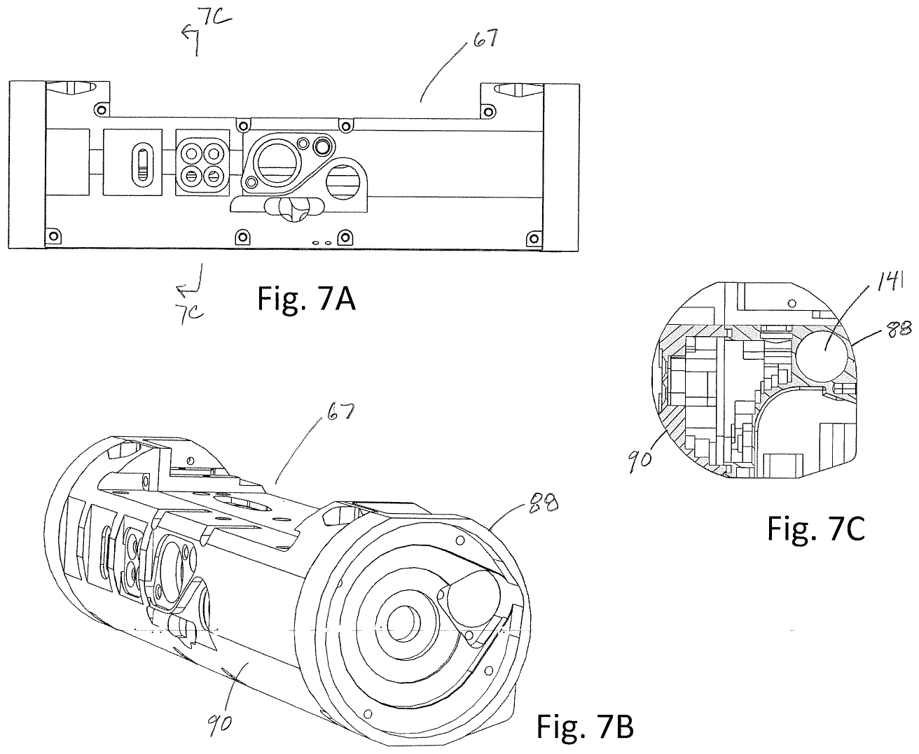

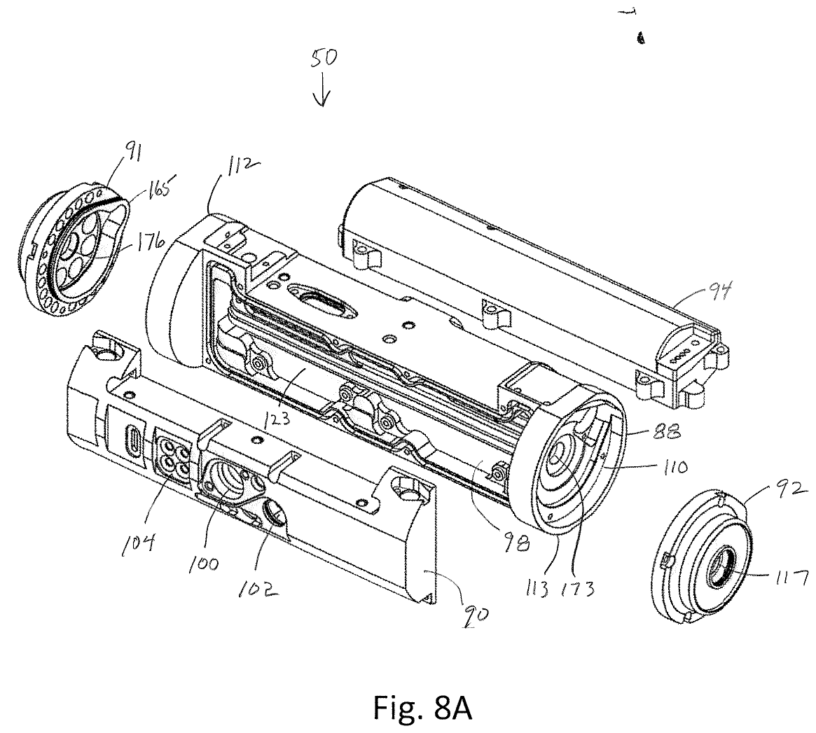

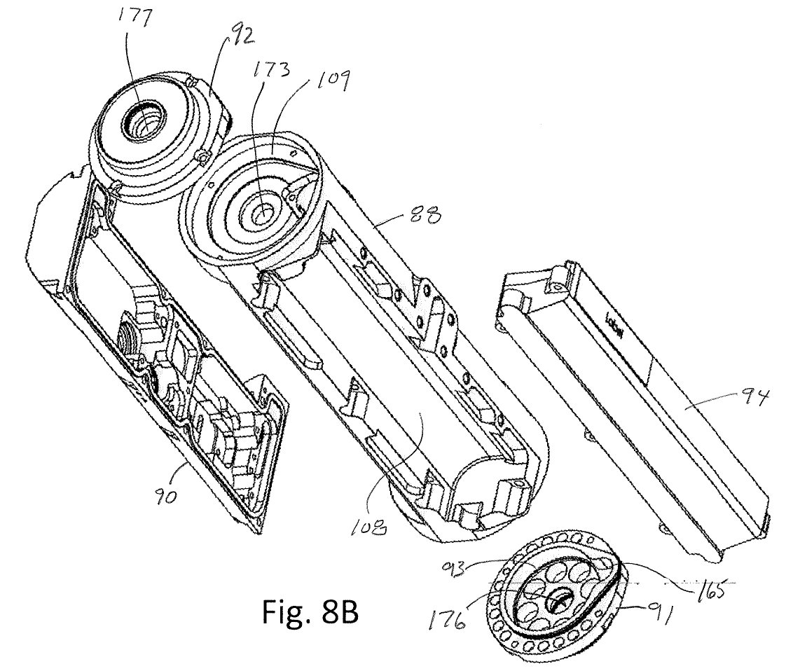

Referring to FIGS. 7A-11, components of chassis 50 are illustrated and include a main chassis body component 88, a forward chassis component 90, a pair of chassis end caps 91, 92 with recesses 93. Additionally a battery module 94 is secured to the chassis 50 and may define part of the chassis. The main chassis body component 88 defines several U-shaped recesses. “U-shaped” recesses meaning the structure defining the recess has outward facing surfaces that define a U when taken in a cross section along an axial length of the recess. The structure defining the recess will have a bottom surface and walls with surfaces extending at a perpendicular angle (or an angle of about 70 to 110 degrees) to the bottom surface.

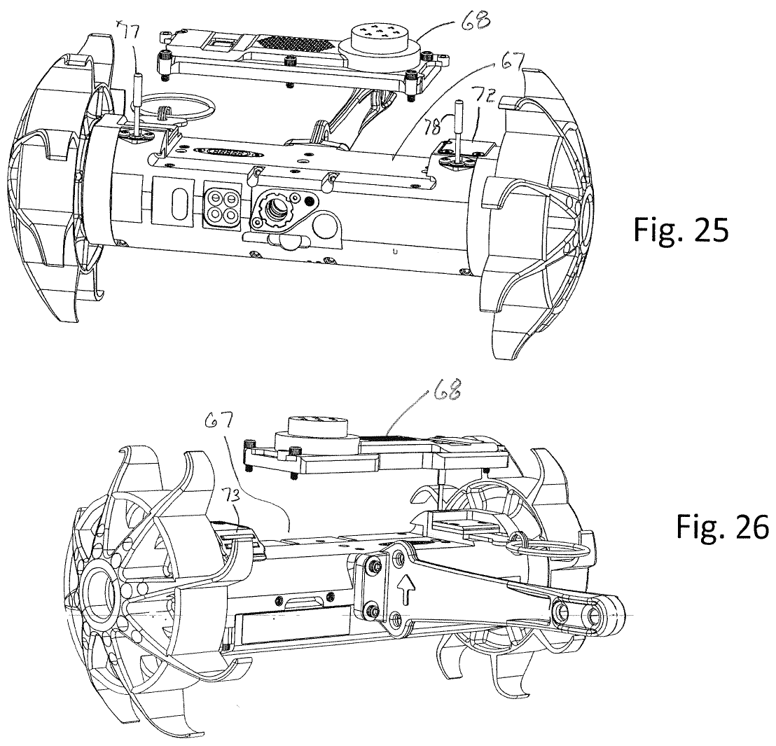

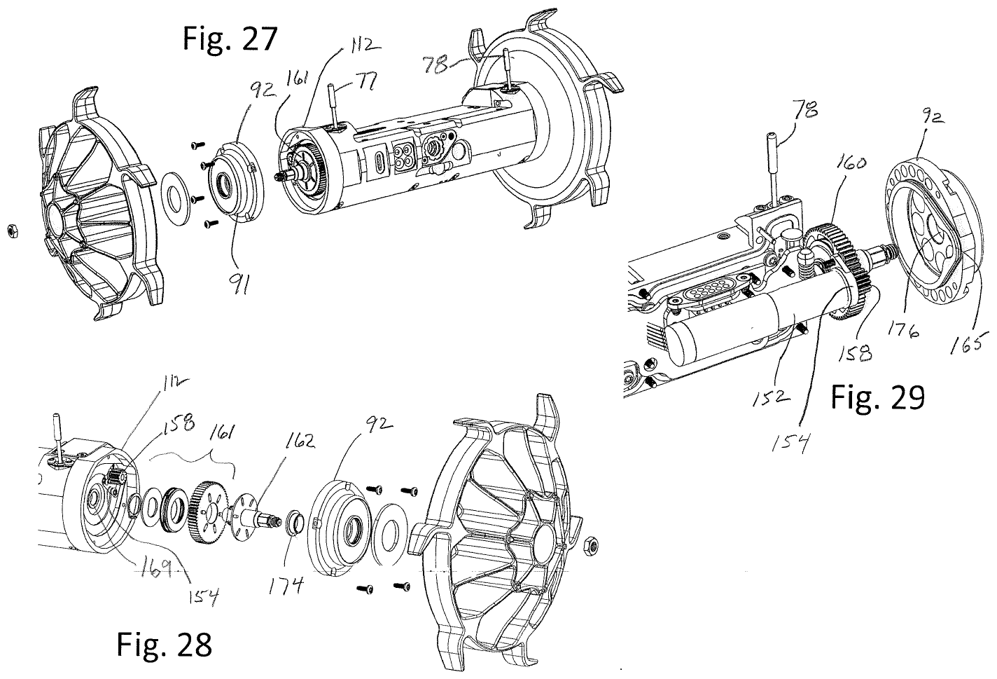

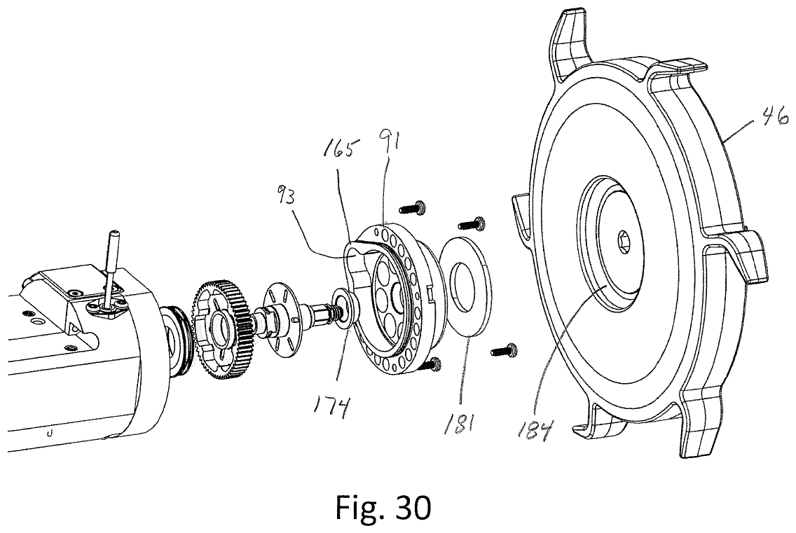

Referring to FIGS. 1-7B and 25-26, the chassis and the main chassis body component 88 has a U-shaped top side accessory recess 67, a forward U-shaped recess 98 that receives circuitry and other components and also receives the forward chassis component 90. The forward chassis component 90 configured as a panel also has an upwardly facing recess that conforms to the main chassis body component recess and may have a seal or gasket 99 at the juncture of the main chassis body component and the forward chassis component. The forward chassis component having a plurality of portals 100, 102, 104 for the cameras 60, 62, illumination components 64, and IR sensor 65. A further U-shaped recess 108 is the recess for the battery module. The battery module recess 108 also has a U-shape in a cross section taken at a plane transverse to the axis of the chassis. The portals are suitable sealed by lenses or the actual sensor or other component exposed therethrough.

In embodiments the top side accessory recess extends inwardly from the outer periphery of the chassis more than 0.4 inches the entire length of the accessory recess. In embodiments, the top side recess extends inward less than 1.3 inches. In embodiments, the accessory recess extends inwardly more than 0.75 inches.

The main chassis body 88 also has a pair of inward and axially extending end recesses 109, 110 at each end 112, 113 of the component. These recesses have a U-shaped when viewed in a cross section. The end recesses 109, 110 along with the chassis end caps 91, 92 provide a containment or compartment that contain the gear system and clutch mechanism for the drive wheels and is substantially isolated therein.

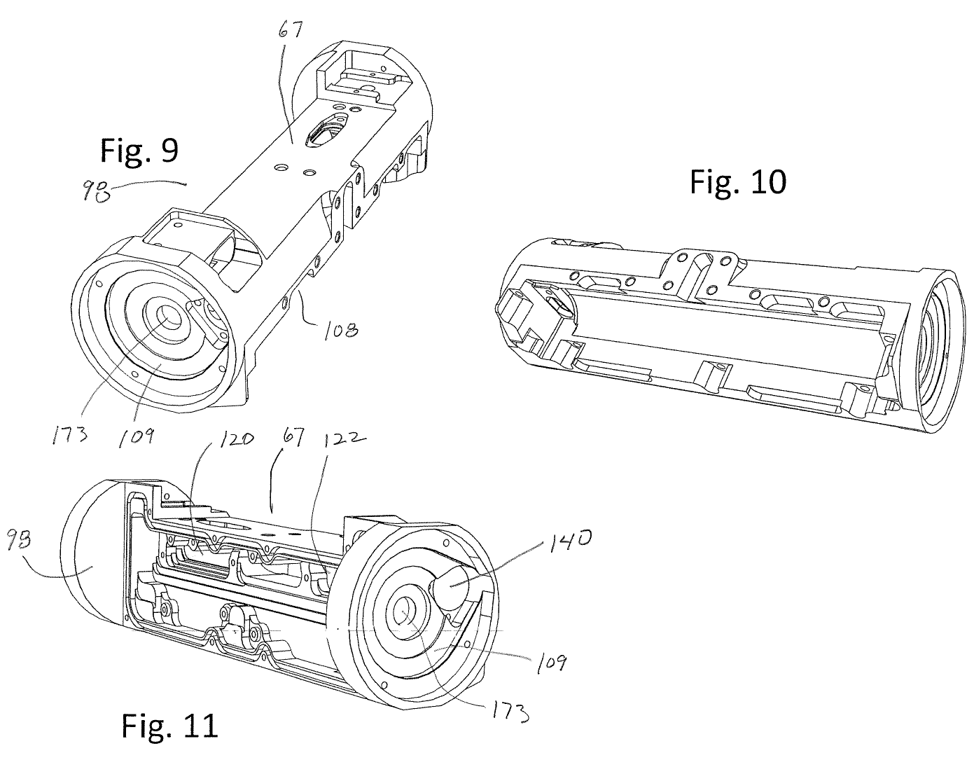

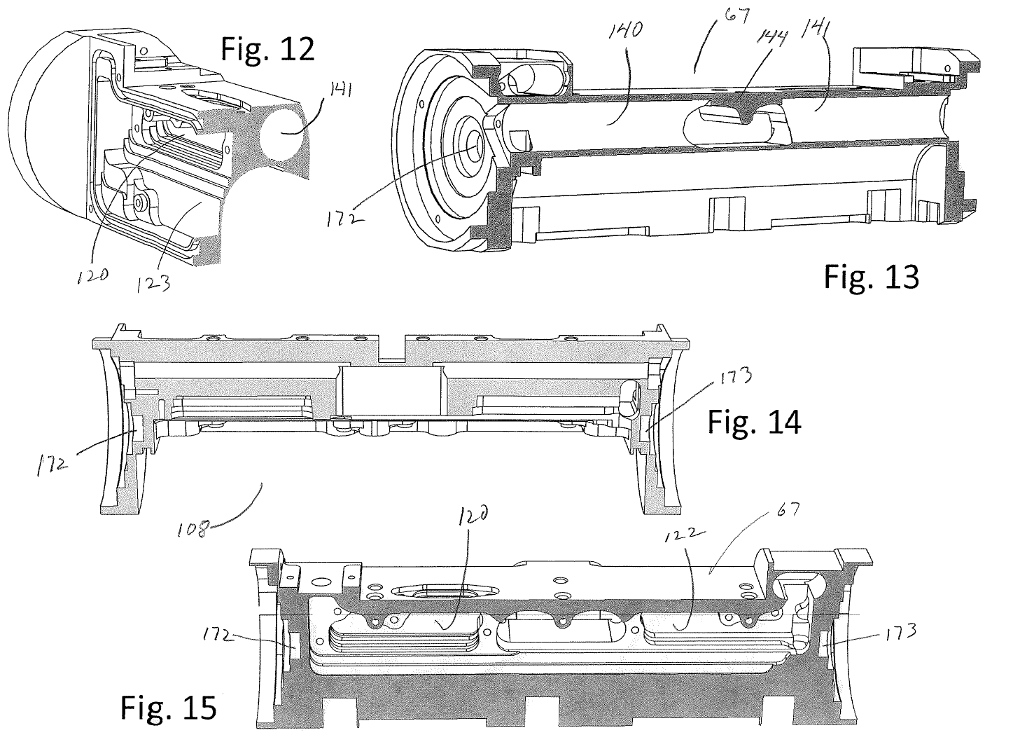

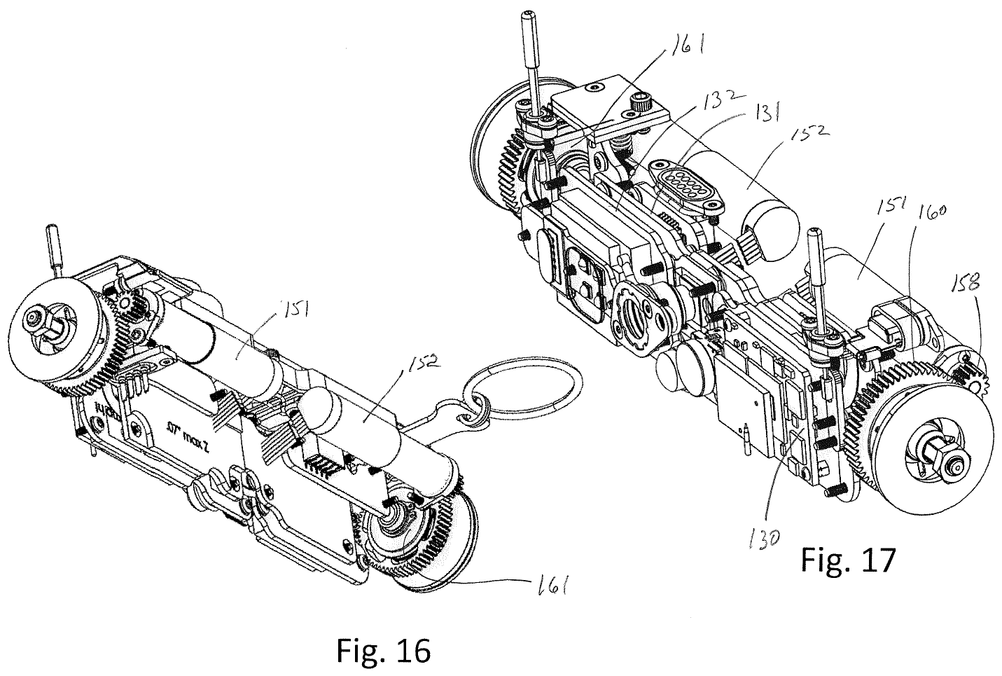

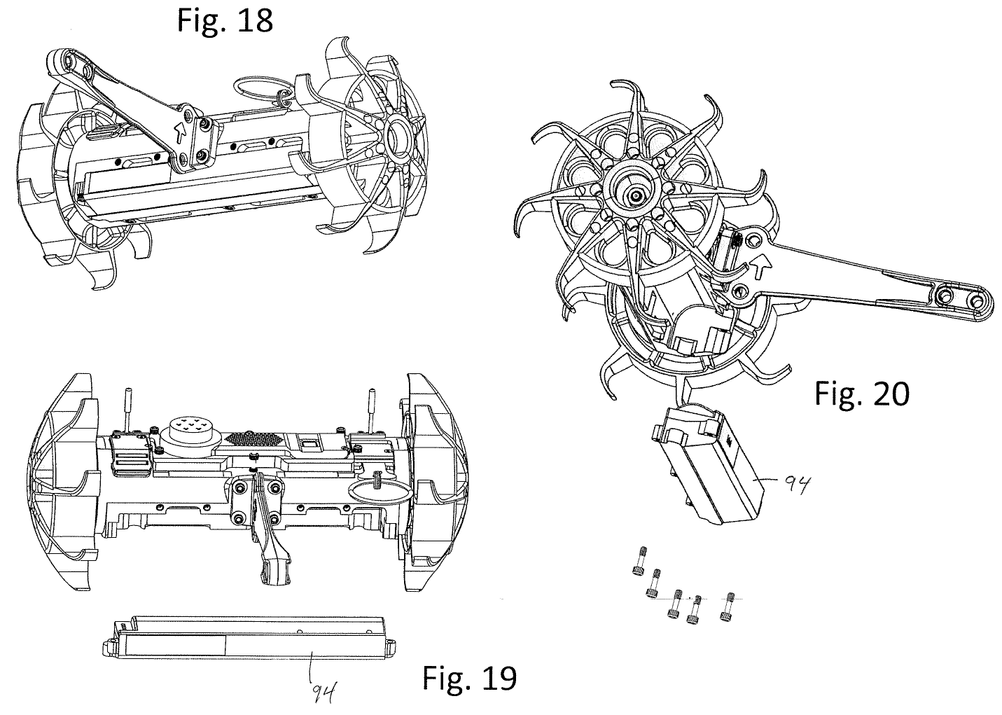

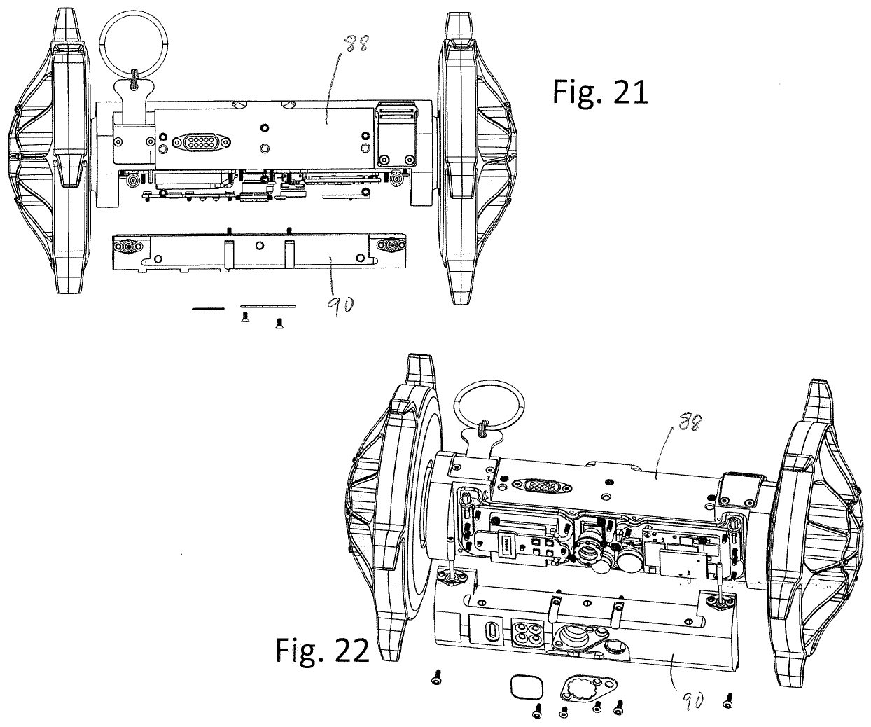

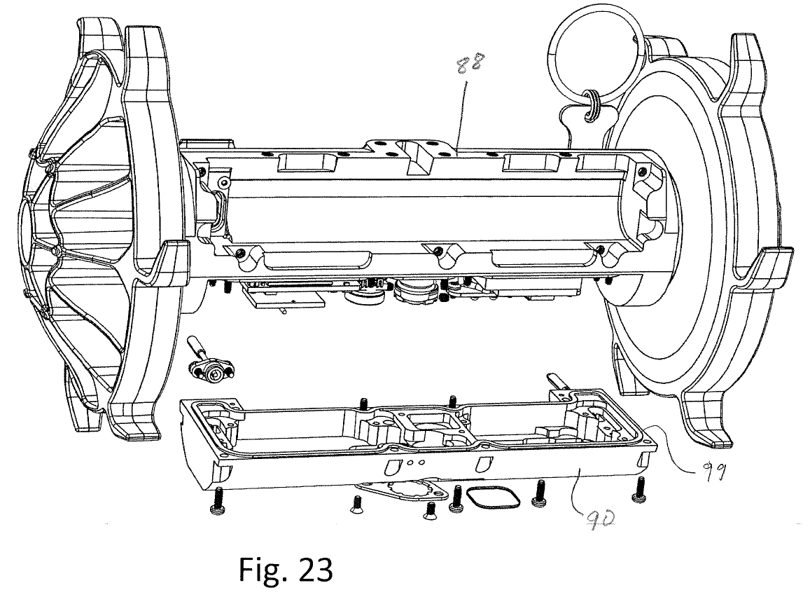

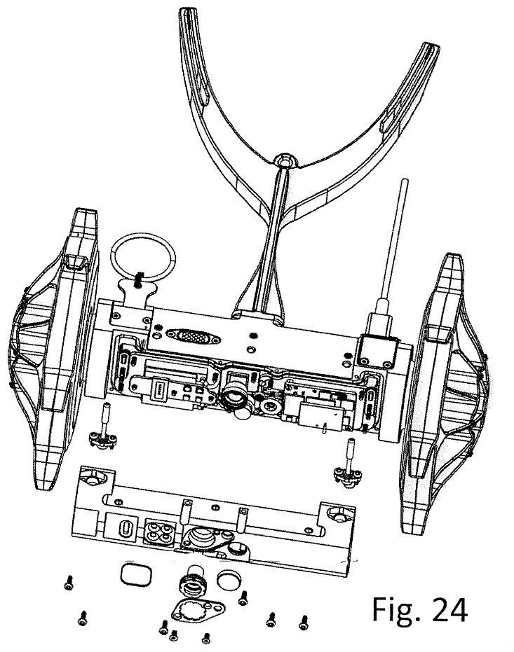

Referring to FIGS. 9-17 and 21-24, details of the support of the internal componentry by the chassis 50 are illustrated. The main chassis body 88 and forward chassis component 90 define a plurality of circuitry compartments 120, 122, 123 that receive circuitry 125 that comprise printed circuit boards with componentry which may include processing circuitry 130, power control/management circuitry 131, radio/communications circuitry 132, video processing circuitry, memory and the like. The processing may include artificial intelligence capabilities providing the robot with, for example, autonomous decision making and operating capabilities.

The main chassis body has two bores 140, 141 extending from the end recesses 109, 110 to the central portion 144 of the main chassis body. The bores are conformingly sized for the two drive motors 151, 152 that may include encoders. Motor flanges 154 may be attached to the drive shaft end of the motors with fasteners and the flange connected to the main chassis body at the aperture extending into the respective bore. The drive motors are connected to control circuitry and have an output shafts with a drive gear 158 thereon that is engaged with a larger driven gear 160 that is coupled through clutch mechanisms 161 to the respective drive wheels by axles 162. The clutch mechanism 161 and driven gear and axles 162 are supported by bushings 169 in the central recesses 172, 173 at the end portions 112, 113 of the main chassis body component 88 and bushings 174 the bore 176, 177 in the chassis end caps providing a high level of containment and strength. A thrust washer 181 may be positioned between the chassis end cap and the drive wheel. The thrust washer may be a polymeric material providing a low coefficient of friction and shock absorbing function. The central projecting part of the chassis end caps my extend into a central interior facing recess 184 of the drive wheels. The chassis end caps have an outer radial projecting portion 165 that may be bulbous and that provides a radial expansion of the recess 93 for accommodating the drive gear 158 engaged with the driven gear.

See U.S. Pat. Pub. No. US 2020/0282569 which is incorporated by reference for all purposes for further disclosure of drive systems including clutch mechanisms.

The main chassis body component being unitary and supporting the drive motors in the bores, rather than using brackets for example, and with the drive system supported by the drive system bores

Additional known two wheeled throwable robots are disclosed, for example, in U.S. D637217, U.S. Pat. Pub. US 20100152922, and U.S. Pat. No. 6,548,982. The contents of which are incorporated by reference herein.

1. A throwable robot having a pair of drive wheels supported by a chassis extending between the drive wheels, a rearwardly extending tail attached to a rearward facing central portion of the chassis, the chassis comprising a main chassis component with a pair of axial end portions adjacent each drive wheel, each end portion having a forward extending collar portions with an inward and forward facing chassis recess defined between the forward extending collar portions, a forward chassis panel attached to the main chassis component and extending continuously between the two collar portions in said inward and forward facing chassis recess, the main chassis component and the forward chassis panel defining an interior compartment in the chassis, the forward panel having a plurality of access portals for a camera and illumination components positioned in the interior compartment.

2. The throwable robot of claim 1, wherein the interior compartment is isolated and sealed from one or more drive motors that drive the drive wheels.

3. The throwable robot of claim 2, wherein the main chassis component defines a lower axially extending battery module recess for receiving a battery module, the robot further comprising a battery module secured to the main chassis component in said battery module recess, the battery module providing an exterior surface of the robot at a bottom side of the robot and at a rearward side of the robot.

4. The throwable robot of claim 1, wherein each forward extending collar portions have an arcuate cylindrical forward surface and wherein the forward chassis panel has a shape that at least partially conforms to and is flush with the arcuate cylindrical forward surfaces of the forward extending collar portions.

5. A throwable robot that has an elongate body portion extending between just two drive wheels, each drive wheel having an inwardly facing circular recess, a rearward extending tail positioned attached to the body portion and extending rearwardly, the body portion comprising a chassis, the chassis comprising a unitary metal main chassis component extending the length of the outer surface of the body, the chassis further comprising a pair of chassis end caps that define compartments at each end of the body at each of the two drive wheels, the end caps each projecting inwardly into the respective inward circular recesses of the drive wheels.

6. The throwable robot of claim 5, further comprising a pair of drive systems each comprising a plurality of drive gears and a clutch mechanism, and wherein each of the end caps contain one of the pair of the drive systems.

7. The throwable robot of claim 6, further comprising a pair of drive motors, and wherein the main chassis component has a pair of bores conformingly sized to the pair of drive motors and wherein the drive motors are secured in respective ones of the pair of bores.

8. The throwable robot of claim 5, wherein the robot weighs less than 6 pounds and has an axial length of less than 14 inches.

9. (canceled)

10. A throwable robot having an elongate body positioned between two wheels, the body comprising a chassis with a central axis extending therethrough that defines the exterior surface of the body, the chassis having an outermost surface with a radius that is at least 1.5 inches less than an undeflected maximum radius of each of the wheels, the chassis having a unitary main chassis body component with a pair of end portions each with an outer periphery adjacent to and spaced from each wheel, each end portion defining the maximum radius of the chassis, the main chassis body having three circumferentially spaced axial extending recesses that each extend continuously most of the axial distance between the wheels and each are at least 0.5 inches in radial depth from the periphery of the pair of end portions.

11. The throwable robot of claim 10, further comprising an exteriorly exposed battery module, and wherein one of the three axially extending recesses in the main chassis body component is a battery module recess conformingly shaped for a battery module.

12. The throwable robot of claim 10, wherein one of the three axially extending recesses is a forward facing recess positioned on a front side of the main chassis body, and wherein the chassis further comprises a forward chassis component that is conformingly sized to and received by the main chassis body at the forward recess, the forward chassis component being unitary and extending most of the axial distance between the pair of wheels, and wherein the forward chassis component and the main chassis body component define at least one component compartment that receives one or more circuit boards with one or more forward facing sensors and operational components mounted thereon, the forward chassis component configured as a panel with a plurality of portals such that the one or more forward facing sensors and operations are forwardly exposed with respect to the robot.

13. The throwable robot of claim 10, wherein the main chassis component has a top side payload or accessory recess for receiving a payload or accessories, the recess defined by a upwardly facing flat surface, an electrical connector with a plurality of contact points positioned at the upwardly facing flat surface.

14. The throwable robot of claim 12, wherein the robot further comprising circuitry that is on the one or more circuit boards that includes processing circuitry and radio circuitry permitting communications with and control by a remote control unit.

15. The throwable robot of claim 10, wherein the main chassis component comprises a pair of circular axially extending recesses at each of the end portions of the main chassis component, and wherein the chassis further comprises a pair of chassis end caps that are conformingly sized for and are received in or at each respective one of the pair of axially extending recesses, and wherein each of the drive wheels is attached to an axle extending out from central apertures of each of the respective ones of the pair of chassis end caps.

16. The throwable robot of claim 15, wherein each of the chassis end caps attached to the circular axially extending recesses at each end portion contain a drive gear system and a clutch system.

17. The throwable robot of claim 16, wherein the circular recess is defined by a closed wall that extends from the axle axis radially outward.

18. The throwable robot of claim 16 wherein at each end portion an inner end of the axle is seated in a closed recess on a wall defining the circular axially extending recess.

19. The throwable robot of claim 16, wherein the robot comprises a pair of drive motors that are each contained in a respective axially extending bore in the main chassis component, each bore positioning an output shaft with a drive gear in the containment defined by each chassis end cap and the circular recess at each end portion.

20-22. (canceled)
